(19) United States
(12) Patent Application Publication
(10) Pub. No.: US 2012/0063727 A1
(43) Pub. Date: Mar. 15, 2012

(54) CONNECTOR ASSEMBLY WITH ELECTRICAL AND OPTICAL TRANSMITTING

(75) Inventor: JERRY WU, Irvine, CA (US)

(73) Assignee: HON HAI PRECISION INDUSTRY CO., LTD., New Taipei (TW)

(21) Appl. No.: 13/231,986

(22) Filed: Sep. 14, 2011

(30) Foreign Application Priority Data
Sep. 15, 2010 (CN) 201020529967.6

(51) Int. Cl. G02B 6/36

(52) U.S. Cl. 385/88

(57) ABSTRACT

A connector assembly includes a plug connector (1000) and a receptacle connector (2000). The plug connector (1000) includes a first insulative housing; at least one terminal supported by the first insulative housing; at least one optical member mounted to the first insulative housing, the optical member having a first lens (81). The receptacle connector (2000) includes a second insulative housing; a contact supported by the second insulative housing and adapted for mating with the terminal; a second lens (2082) mounted to the second insulative housing; a guiding element (203) supported by the second insulative housing, the guiding element defining a guiding passage to receive the second lens; and the first lens extending into the guiding passage and aligning with the second lens when the plug connector mating with the receptacle connector.

### FIELD OF THE INVENTION

The present invention generally relates to a connector assembly, and more particularly to a connector assembly for electrical and optical transmitting.

### DESCRIPTION OF PRIOR ART

With development of interconnection technique, a wide range of electrical connector assemblies in accordance with USB, SATA, HDMI, SAS and Displayport transmitting protocol have been widely applied in different kinds of electronic devices. The aforementioned connector assemblies depend on metallic terminals and copper wires to achieve electrical signal transmitting. However, transmitting speed is limited via electrical signal transmitting. In other aspect, with transmitting speed increasing, a structure of the connector assembly becomes complex, and a total dimension of the cable assembly is increasing.

CN Pub. Pat. No. 101345358 published on Jan. 14, 2009 discloses an optical USB connector assembly which has a fiber device added to a USB connector assembly. The connector assembly includes a plug connector and a receptacle connector. The plug connector has an insulative housing with a plurality of first terminals and a number of first lenses fixed thereto. The receptacle connector has an insulative housing with a plurality of second terminals and a number of second lenses fixed thereto. The first terminals mate with the second terminals to transmitting electrical signal. The first lenses couple with the second lenses to transmit optical signal. However, as the lenses are fixed in the insulative housing and lack of self-aligning function, and if there are some error in manufacturing, the first lens and the second lens may improperly mated.

Hence, an improved connector assembly is highly desired to overcome the aforementioned problems.

### SUMMARY OF THE INVENTION

Accordingly, an object of the present invention is to provide a lower profile and easily manufactured connector assembly for electrical and optical transmitting.

In order to achieve the object set forth, a connector assembly in accordance with the present invention comprises a plug connector and a receptacle connector mating with each other for electrical and optical transmitting. The plug connector comprises a first insulative housing; at least one terminal supported by the first insulative housing; at least one optical member mounted to the first insulative housing, the optical member having a first lens. The receptacle connector comprises a second insulative housing; a contact supported by the second insulative housing and adapted for mating with the terminal; a second lens mounted to the second insulative housing; a guiding element supported by the second insulative housing, the guiding element defining a guiding passage to receive the second lens; and the first lens extending into the guiding passage and aligning with the second lens when the plug connector mating with the receptacle connector.

Other objects, advantages and novel features of the invention will become more apparent from the following detailed description when taken in conjunction with the accompanying drawings.

### BRIEF DESCRIPTION OF THE DRAWINGS

FIG. 1 is an assembled, perspective view of the plug connector of a connector assembly in accordance with the present invention;

FIG. 2 is an exploded, perspective view of the plug connector;

FIG. 3 is similar to FIG. 2, but viewed from another aspect;

FIG. 4 is an assembled, perspective view of a receptacle connector of the connector assembly in accordance with the present invention;

FIG. 5 is an exploded, perspective view of the receptacle connector;

FIG. 6 is similar to FIG. 5, but viewed from other direction;

FIG. 7 illustrates the plug connector and the receptacle connector in mated state;

FIG. 8 is a partial cross-section view taken along line 8-8 of FIG. 7; and

FIG. 9 is a cross-section view taken along line 9-9 of FIG. 7.

### DETAILED DESCRIPTION OF PREFERRED EMBODIMENTS

Reference will now be made in detail to the preferred embodiment of the present invention.

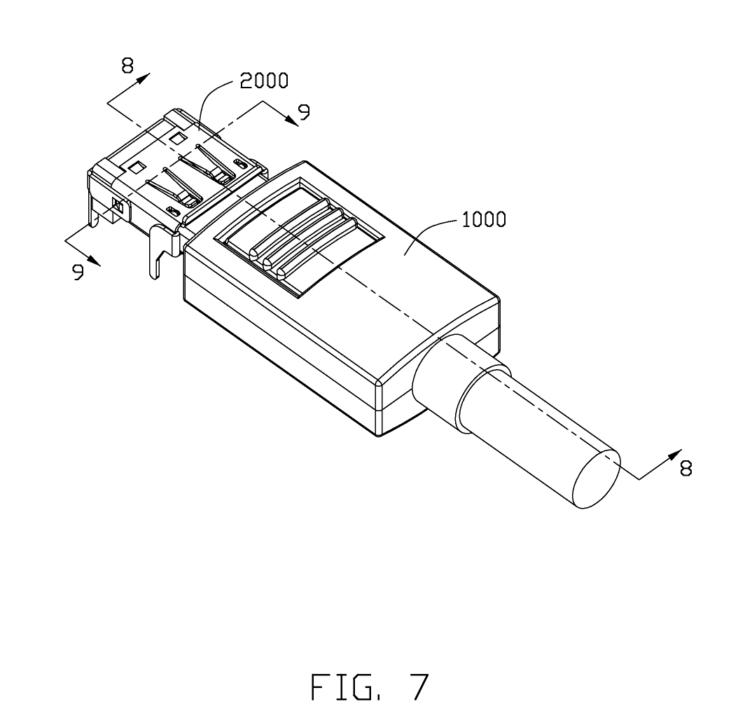

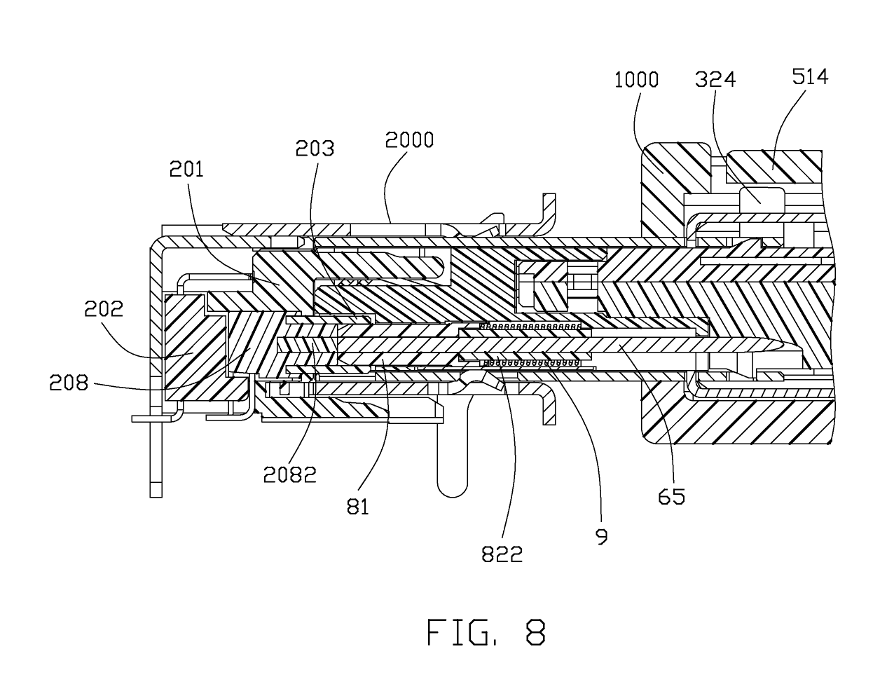

Referring to FIGS. 7-8, a connector assembly for electrical and optical signal transmitting comprises a plug connector 1000 and a receptacle connector 2000.

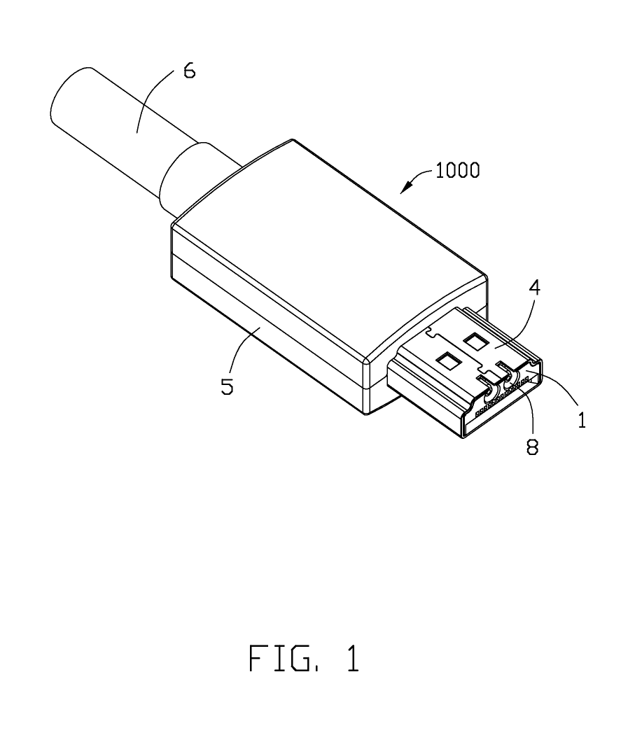

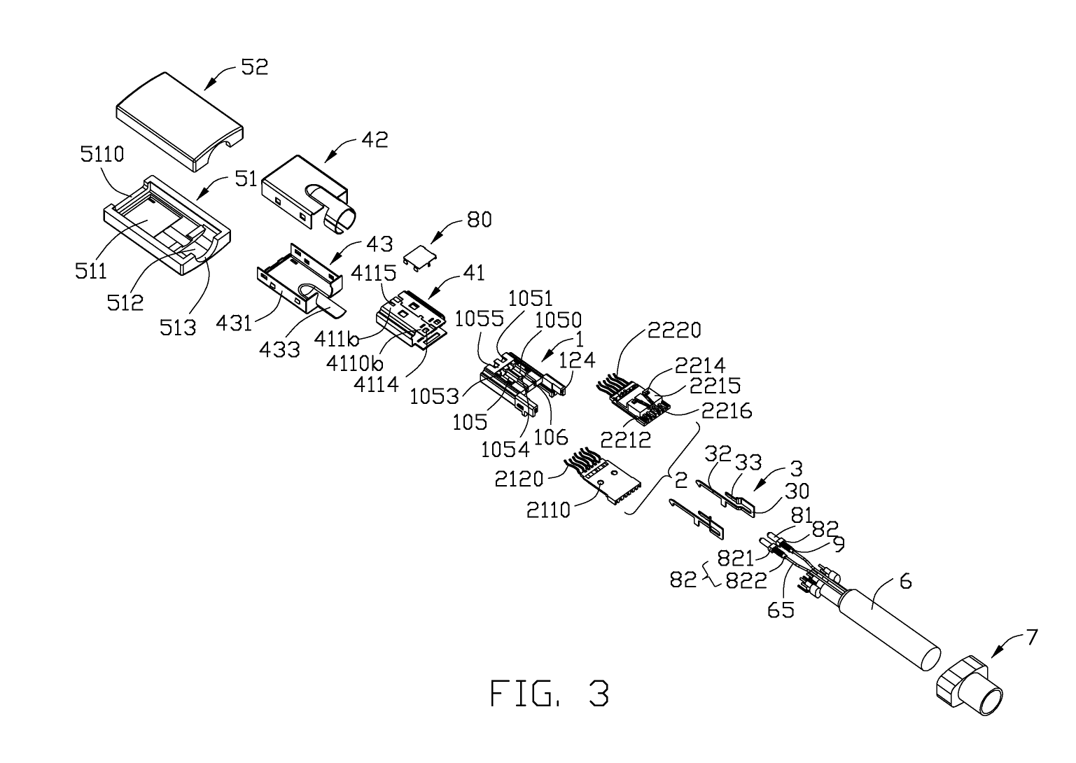

Referring to FIGS. 1-3, the plug connector 1000 comprises a first insulative housing 1, a terminal module 2 supported by the first insulative housing 1, two latching members 3 mounted to the first insulative housing 1, a first metallic shell 4 shielding the first insulative housing 1, an external cover 5, a cable 6, a strain relief 7 and two optical members 8.

The first insulative housing 1 includes a main portion 10 and two mounting arms 12 extending rearwardly from lateral sides of the main portion 10. A receiving space 102 is recessed forwardly from a middle segment of a rear edge of the main portion 10. A cavity 104 is recessed downwardly from a front segment of a top side of the main portion 10 and further communicates with the receiving space 102. A slot 101 is defined in the mounting arm 12 and partial of main portion 10 in front of the mounting arm 12. A positioning hole 124 is defined in a rear portion of the mounting arm 12. There are two grooves 105 located in a bottom side of the main portion 10. Each groove 105 extends along a front-to-back direction. The groove 105 has a front portion 1051 smaller than a back portion 1050 thereof There is a transversal bar 1055 crossing over and located at a bottom side of the front portion 1050. There are two passages 106 are located behind and communicate with the two grooves 105. The passage 106 is narrower than the corresponding groove 105 which is located in front. There are four first positioning holes 1053 arranged at outer sides of the two grooves 105. In addition, there is a second positioning hole 1054 located behind the two passages 106.

The terminal module 2 includes a first terminal module 21 and a second terminal module 22. The first terminal module 21 has an insulator 211 and a number of terminals 212 combined together by insert-molding process. The terminals 212 are divided into signal terminals and grounding terminals configured to be longer than the signal terminals. The terminals 212 have contacting portions 2120 disposed in front of an edge of the insulator 211 and tail portions which are accommodated in terminal slots 2112 defined in a back segment of the insulator 211. Two mounting holes 2110 are defined in a bottom side of the insulator 211 and a protruding portion 2111 are formed on a top side of the insulator 211.

The second terminal module 22 has an insulator 221 and a number of terminals 222 combined together by insert-molding process. The terminals 222 are divided into signal terminals and grounding terminals configured to be longer than the signal terminals. The terminals 222 have contacting portions 2220 disposed in front of an edge of the insulator 221 and tail portions which are accommodated in terminal slots 2212 defined in a back segment of the insulator 221. Two mounting posts 2210 are formed on a top side of the insulator 221. There is a platform 2215 on the bottom side of the insulator 221 and there are two fiber channels 2216 defined in the platform 2215. In addition, there are two protruding portions 2214 formed on a bottom side of the platform 2215.

The first terminal module 21 and the second terminal module 22 are stacked with each other, with the contacting portions 2120, 2220 merged into one row, while the tail portions separated into two distinct rows along an up-to-down direction. The mounting posts 2210 are inserted into the mounting holes 2110 so as to keep the first terminal module 21 and the second terminal module 22 together. The first terminal module 21 and the second terminal module 22 are assembled to the insulative housing 1, with front segments of the insulators 211, 221 inserted into the receiving space 102, and the contacting portions 2120, 2220 accommodated in the cavity 104.

Each latching member 3 includes a connecting arm 30, a latching arm 32 and a retention arm 33. The latching arm 32 and the retention arm 33 are spaced apart from each other and extend forwardly from the connecting arm 30. Each latching arm 32 has a hook 322 formed at a front end thereof and projects upwardly. There is also a tab 324 formed on a middle of the latching arm 32 and protrudes upwardly. The latching arm 32 and the retention arm 33 are located in a first vertical plane. The connecting arm 30 is located in second vertical plane outward the first vertical plane.

The metallic shell 4 has a first shell 41, a second shell 42 and a third shell 43. The first shell 41 includes a first frame 411 to accommodate the main portion 10 therein. The first frame 411 has a top side 411a and a bottom side 411b connected with each other by two lateral sides. There are two through holes 4110 located in a front segment of a top side 411a to allow the hooks 322 of the latching arm 32 passing through. A first engaging portion 4110a projects backward from the top side 411a. There is a positioning hole 4112 defined in the first engaging portion 4110a to latch with the protruding portion 2111 of the first terminal module 21. A second engaging portion 4110b projects backward from the bottom side 411b of the first frame 411. There are two positioning holes 4114 defined in the second engaging portion 4110b to latch with the protruding portions 2214 of the second terminal module 22. In addition, there are two notches 4115 defined in a front edge of the bottom side 411b.

The second shell 42 includes a U-shaped main body 421 and a cable holder 423 integrated with the main body 421 and projecting backwardly. The third shell 43 includes an inverted U-shaped main portion 431 and a tail 433 extending rearward. The second shell 42 and the third shell 43 can be combined together along a vertical direction.

The external cover 5 includes an upper cover 51 and a bottom cover 52. The upper cover 51 has a first hollow 511 and a second hollow 512 disposed behind the first hollow 511. A rectangular shaped opening 5110 is located in the front portion of the upper cover 51, and the opening 5110 further communicates with the first hollow 511. A semicircular shaped outlet 513 is defined in the rear portion of the upper cover 51 and communicated with the second hollow 512. A deformable button 514 is integrally formed with the upper cover 51 and floatable along up-to-down direction to enter the first hollow 511 so as to actuate the tab 324 of the latching arm 32.

The bottom cover 52 is similar to the upper cover 51, and also has a first hollow 521 and a second hollow 522 disposed behind the first hollow 521. An opening 5210 is located in the front portion of the bottom cover 52, and the opening 5210 further communicates with the first hollow 521. A semicircular shaped outlet 523 is defined in the rear portion of the bottom cover 52 and communicated with the second hollow 522.

The cable 6 is a hybrid cable and includes a number of wire groups and two fibers 65 enclosed in a jacket 60. Each wire group includes a pair of signal wires 62 and a grounding wire 61 associated with the pair of signal wires 62, and a shielding member 63 shrouding the pair of wires 61 and the grounding wire 62. The shielding member 63 is aluminum foil or other similar structure. The strain relief 7 is molded over a front segment of the cable 6 and accommodated in the second hollows 512, 522.

Each optical member 8 includes a cylindrical shape first lens 81 and a ferrule 82 combined with a back part of the first lens 81. The first lens 81 has a narrowed front end. The ferrule 82 has a flange 821 adjacent to the back part of the first lens 81 and a guiding post 822 projecting backwardly from the flange 821. The fiber 65 extends through the guiding post 822 and further optically coupled with the first lens 81. There is a coil spring 9 associated with the guiding post 822 and against the flange 821, with a back free end of the guiding post 822 backwardly extending beyond the coil spring 9. One of the two optical members 8 transmits optical signal, and the other optical members 8 receives optical signal.

The two optical members 8 are accommodated in the two grooves 105, respectively. The first lens 81 is received in the front portion 1051 of the groove 105, and the ferrule 82 is received in the back portion 1050 of the groove 105. The coil spring 9 is received in the back portion 1050 of the groove 105 and biases/pushes the optical member 8 forwardly. The flange 821 is larger than the front portion 1050 so as to prevent the optical member 8 sliding away the groove 105. The guiding post 822 extends into the passage 106 and is capable of moving therein along the front-to-back direction. The fiber 65 passes through the corresponding fiber channel 2216.

The plug connector 1000 further comprises a cap member 80 mounted to the first insulative housing 1 to prevent the optical members 8 and the coil spring 9 falling off therefrom. The cap member 80 includes a plate-like body segment 801 shielding the two grooves 105, four first engaging parts 802 extending upward from two lateral sides of the body segment 801 and inserted into the four first positioning holes 1053, respectively, and a second engaging part 803 extending upward from a back side of the body segment 801 and inserted into the second positioning hole 1054.

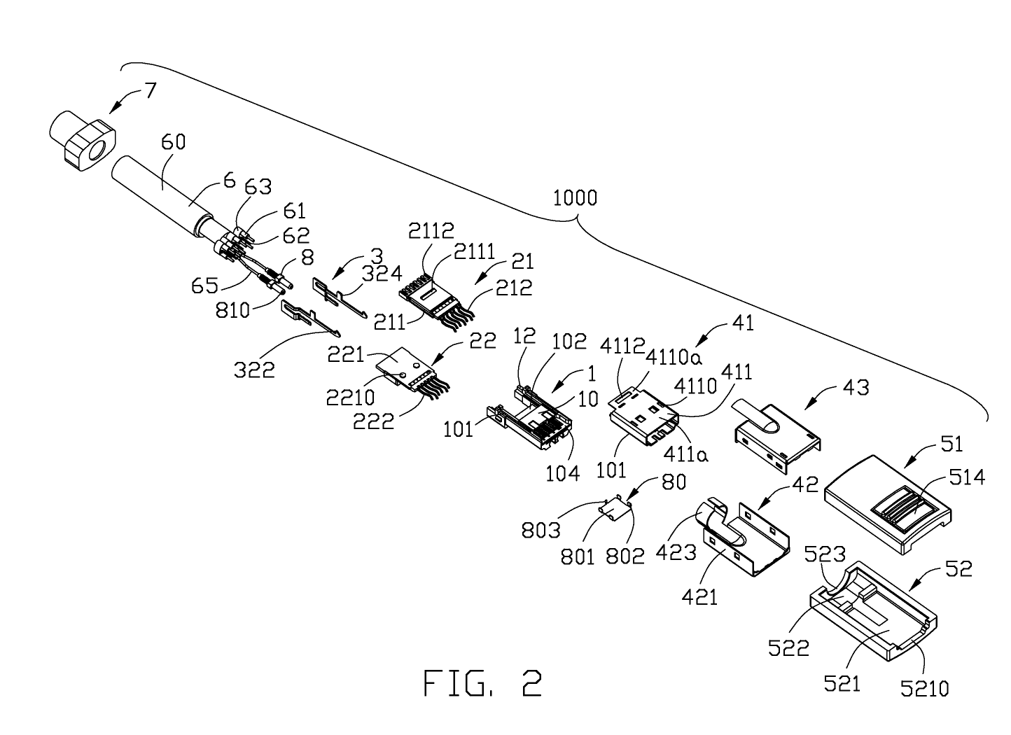

The plug connector 1000 is compatible with DiiVA (Digital Interactive Interface for Video & Audio) standard. Referring to FIGS. 1-2, within the cavity 104, along a left-to-right direction, there are thirteen terminals 212, 222 which are arranged in such manner: G-S-S-G-S-S-G-S-S-G-G-S-S. G represents grounding terminal, and S represent signal terminal There are three differential pairs consisted of six signal terminals located between grounding terminals. The differential pairs used for conveying video signals. And a pair of signal terminals disposed at the right side are used for audio signals.

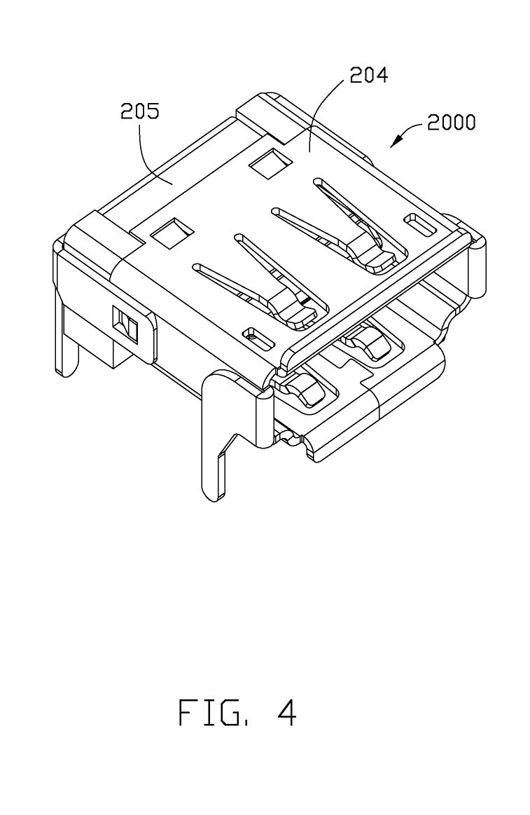

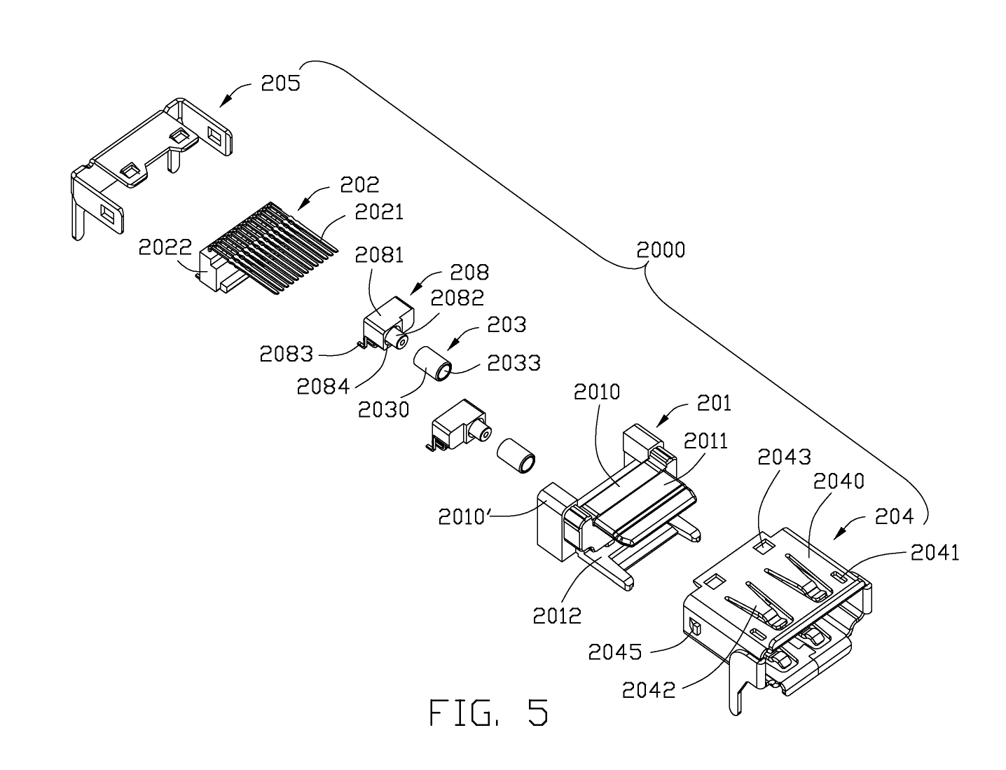

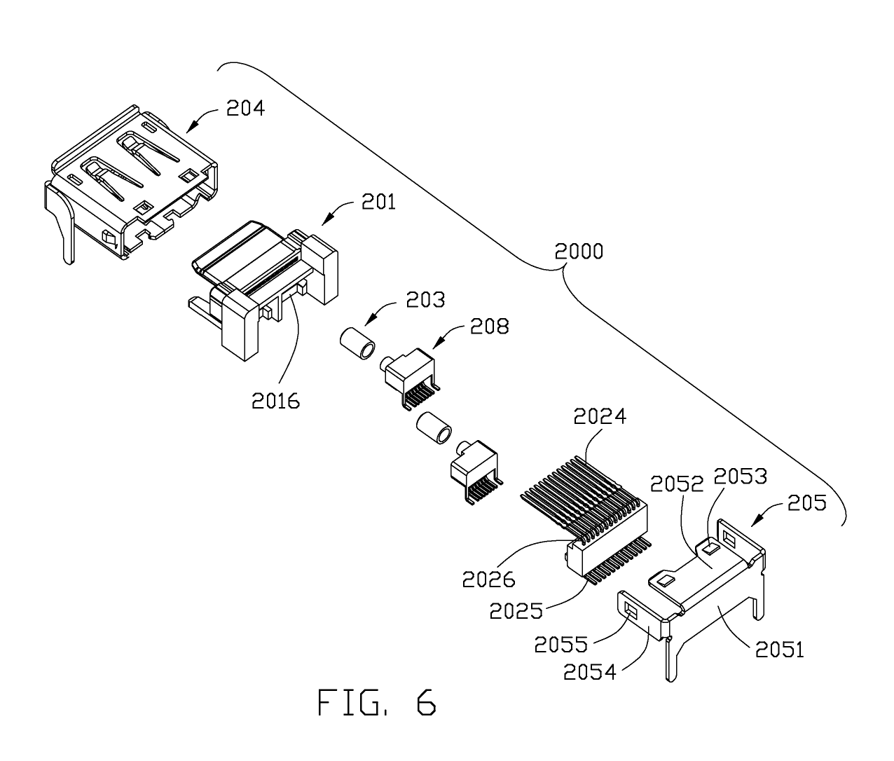

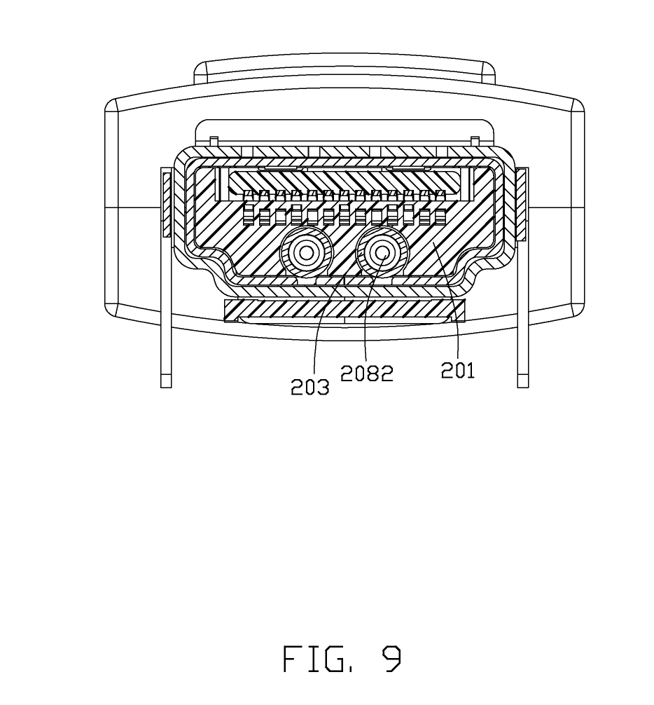

Referring to FIGS. 4-6 and 9, the receptacle connector 2000 comprises a second insulative housing 201, a contact module 202 supported by the second insulative housing 201, two guiding elements or guiding members 203, a second metallic shell 204 shielding the second insulative housing 201, a back cover 205 and two optical modules 208.

The second insulative housing 201 includes a base portion 2010, an upper tongue portion 2011 extending forwardly from an upper segment of the base portion 2010, a lower tongue portion 2012 extending forwardly from a lower segment of the base portion 2010. In addition, there are two attachments 2010′ extending backwardly from lateral sides of the base portion 2010. There are two mounting cavities 2016 defined in the base portion 2010. The two mounting cavities 2016 are disposed in juxtaposed manner.

The contact module 202 includes a plurality of contacts 2021 arranged in one row and further combined with a corresponding contact seat 2022. Each contacts 2021 has a contacting segment 2024 extending along a horizontal direction, a retention segment 2026 extending downwardly from a back end of the contacting segment 2024 and inserted molded with the contact seat 2022, and a soldering segment 2025 extending backwardly from lower end of the retention segment 2026.

The contact module 202 is assembled to the second insulative housing 201 along a front-to-back direction, with the contacting segment 2024 passing through the base portion 2010 and disposed under and adjacent to the upper tongue portion 2011.

The second metallic shell 204 has a second frame 2040 for enclosing the second insulative housing 201. There are two pairs of spring tabs 2042 formed on a top side and a bottom side of the second frame 2040 and extending into an interior of the second frame 2040 respectively. There are two latching holes 2041 defined in the front of the top side of the second frame 2040. There are two first holes 2043 defined in a back segment of the top side of the second frame 2040. There are two first protrusions 2045 formed at back segments of two lateral sides of the second frame 2040.

The back cover 205 includes an inverted U-shaped main part 2051, a top shielding part 2052 extending forwardly from a top edge of the body part 2051 and two arms 2054 extending forwardly from lateral edges of the body part 2051. There are two second protrusions 2053 formed on a front segment of the top shielding part 2052. There is a second hole 2055 defined in a back segment of each arm 2054.

Each optical module 208 includes a main portion 2081, a second lens 2082 combined with the main portion 2081 and a plurality of pins 2083 extending downwardly from the main portion 2081. Furthermore, there is circular recess 2084 defined in the main portion 2081 and surrounding a back portion of the second lens 2082. The guiding element 203 has a tubular guiding portion 2030 with a cylindrical guiding passage 2033 extending along an axial direction thereof. The guiding portion 2030 is fixed to the circular recess 2084, with the second lens 2082 extending into the guiding passage 2033 from a back-to-front direction. The second lens 2082 fully matches with the guiding passage 2033. In alternative embodiment, the guiding element may directly supported or mounted to the second insulative housing.

The two optical modules 208 are respectively assembled to the corresponding mounting cavity 2016. Furthermore, the two optical modules 208 are disposed between the two attachments 2010′ and pressed by the contact seat 2022. One of the two optical modules 208 receives optical signal, and the other optical members 208 transmits optical signal, with regarding to the two optical members 8 of the plug connector. The soldering segment 2025 are located behind the pins 2023.

The back cover 205 is mounted to the second metallic shell 204 along a back-to-front direction. The second hole 2055 of the arm 2054 is engaged with first protrusions 2045 of the second frame 2040. The second protrusion 2053 of the top shielding part 2052 is engaged with the first hole 2043 in the top side of the second frame 2040.

When the plug connector 1000 mates with the receptacle connector 2000, the optical member 8 inserting into the guiding passage 2033 from a front-to-back direction and aligning with the second lens 2082 of the optical module 208, then the optical module 8 sliding in the guiding passage 2033 to approach to and optically coupling with the second lens 2082. Thus, optical signal transmitted via the first lens 81 and the second lens 2082. The first lens 81 is fully matching with the guiding passage 2033 of the guiding member 8 and does not tilting two much along a radial direction. Furthermore, the guiding portion 2030 of the guiding member 203 can move along the notches 4115 so as to facilitating the engagement between the first lens 81 and the second lens 2082. The guiding element 203 inserts into the groove 105 of the first insulative housing 1. The terminal module 2 is electrically connected with the contact module 202, with the terminals 212, 222 mating with the contacts 2021 to transmit electrical signal. The hook 322 of the latching arm 32 locks into the latching hole 2041 in the second frame 2040, thus the plug connector 1000 are reliably engaged with the receptacle connector 2000. When detach the plug connector 1000 from the receptacle connector 2000, just press the deformable button 514 to actuate the tab 324 of the latching arm 32, and the latching arm 32 retreat into the slots 101. When the pressing force is withdrawn, the deformable button 514 restored to its original position, and the latching arms 32 also upwardly movement to their original place.

It will be understood that the invention may be embodied in other specific forms without departing from the spirit or central characteristics thereof The present examples and embodiments, therefore, are to be considered in all respects as illustrative and not restrictive, and the invention is not to be limited to the details given herein.

What is claimed is:

1. A connector assembly, comprising:
a plug connector comprising:
a first insulative housing;
at least one terminal supported by the first insulative housing;
at least one optical member mounted to the first insulative housing, the optical member having a first lens;
a receptacle connector comprising:
a second insulative housing;
a contact supported by the second insulative housing and adapted for mating with the terminal;
a second lens mounted to the second insulative housing;
a guiding element supported by the second insulative housing, the guiding element defining a guiding passage to receive the second lens; and
the first lens extending into the guiding passage and aligning with the second lens when the plug connector mating with the receptacle connector.

2. The connector assembly as recited in claim 1, wherein the first lens match with the guiding passage.

3. The connector assembly as recited in claim 2, wherein the first lens and the guiding passage are both cylindrical shape.

4. The connector assembly as recited in claim 1, wherein the first insulative housing defines a groove and the optical member is capable of moving in the groove.

5. The connector assembly as recited in claim 4, wherein the guiding element inserts into the groove of the first insulative housing when the plug connector mates with the receptacle connector.

6. The connector assembly as recited in claim 4, wherein the optical member further comprises a ferrule combined with a back part of the first lens.

7. The connector assembly as recited in claim 6, wherein the ferrule has a flange adjacent to the back part of the first lens.

8. The connector assembly as recited in claim 7, wherein the groove has a front portion and a back portion larger than the front portion, and the first lens is received in the front portion of the groove, and the ferrule is received in the back portion of the groove.

9. The connector assembly as recited in claim 8, wherein there is a spring received in the back portion of the groove and abutting against the flange to biases the optical member forwardly.

10. The connector assembly as recited in claim 9, wherein the flange is larger than the front portion of the groove so as to prevent the optical member sliding away the groove.

11. The connector assembly as recited in claim 9, wherein the ferrule further has a guiding post projecting backwardly from the flange, and the spring is a coil spring associated with the guiding post.

12. The connector assembly as recited in claim 11, wherein the first insulative housing defines a passage located behind and communicating with the groove, and guiding post extends into the passage and is capable of moving therein along a front-to-back direction.

13. A connector assembly, comprising:
a plug connector comprising:
a first insulative housing;
a plurality of terminals supported by the first insulative housing;
a first lens mounted to the first insulative housing;
a receptacle connector for electrically and optically coupled with the plug connector, comprising:
a second insulative housing;
a plurality of contacts supported by the second insulative housing;
an optical module mounted to the second insulative housing, the optical module having a main portion, a second lens combined with the main portion; and
a guiding element mounted to the main portion of the optical module, with the second lens extending into the guiding element from a back side;
the first lens extending into the guiding element from a front side when the plug connector mates with the receptacle connector.

14. The connector assembly as recited in claim 13, wherein the first insulative housing defines a groove to accommodate the first lens, and the second insulative housing defines a cavity to accommodate the optical module.

15. The connector assembly as recited in claim 14, wherein the first lens is movable in the groove of the first insulative housing, and the second lens is unmovable with regarding to the second insulative housing.

16. The connector assembly as recited in claim 15, wherein there is spring received in the groove to bias the first lens forwardly.

17. The connector assembly as recited in claim 16, wherein there is a cap member assembled to the first insulative housing to shield the grooves and preventing the first lens and the spring falling off therefrom.

18. A hybrid connector assembly comprising:
a receptacle connector including:
a first insulative housing defining a mating cavity forwardly communicating with an exterior with therein a mating tongue extending along a front-to-back direction;
a first metallic shell enclosing the first housing;
a plurality of first electrical contacts disposed in the first housing with first contacting sections exposed upon the mating tongue and first mounting sections located on a rear side of the first housing;
a first optical module disposed in the first housing and including a first front lens behind the mating tongue and forwardly facing toward the mating cavity; and
a sleeve associated with the first housing and having a rear section enclosing a front end section of the first front lens and a front section extending forwardly into the mating cavity and overlapped with the mating tongue in a vertical direction perpendicular to the front-to-back direction.

19. The hybrid connector assembly as claimed in claim 18, further including a plug connector, wherein said plug connector includes a second insulative housing enclosing in a second metallic shell with a plurality of second electrical contacts therein, a second optical module having thereof a second lens back and forth moveable in the second housing under condition that said second lens is disposed in a corresponding groove of the second housing behind a front face of the second housing, and the front section of the sleeve extends into a front portion of the groove to enclose a front portion of the second lens.

20. The hybrid connector assembly as claimed in claim 19, wherein the first optical module is essentially immoveable.
